(19) United States
(12) Patent Application Publication
(10) Pub. No.: US 2004/0197170 A1
(43) Pub. Date: Oct. 7, 2004

(54) Storage racking with noise-deadening rollers

(75) Inventor: Hermann Wurm, Flein (DE)

Correspondence Address: Stephen B. Salai, Esq., Harter, Secrest & Emery LLP, 1600 Bausch & Lomb Place, Rochester, NY, 14604-2711, US

(73) Assignee: Hanel & Co., Altstatten (CH)

(21) Appl. No.: 10/812,684

(22) Filed: Mar. 30, 2004

(30) Foreign Application Priority Data
Apr. 1, 2003 (DE) 203 05 240.4

(51) Int. Cl. B65G 1/00

(52) U.S. Cl. 414/280

(57) ABSTRACT

A storage racking includes a plurality of stacked, spaced tote supports arranged in pairs on opposing sidewalls for receiving platform-type totes for storage items. A storage/retrieval system is provided for moving the totes in and out of bays in said storage racking via a bayway. This bayway includes rollers arranged in the deck of the bayway for horizontal shifting of the totes. To reduce the noise developed in moving the totes in the bayway the tread of the rollers includes a noise-deadening insert.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO A “SEQUENCE LISTING”

Not applicable.

### BACKGROUND OF THE INVENTION

1. Field of the Invention

The invention relates to a storage racking comprising a plurality of stacked, spaced tote supports arranged in pairs on opposing sidewalls for receiving platform-type storage totes, wherein storage/retrieval means are being provided for moving the totes in and out of bays in the storage racking, storage and retrieval of the totes being via a bayway comprising rollers arranged in a deck of the bayway for horizontally shifting the totes.

2. Description of Related Art

Storage rackings of this kind are provided for automated storage and retrieval of storage items differing in height for optimized utilization of available space for storage.

Such rackings are already known as disclosed, for instance, in EP 0 722 894 B1 describing a racking system featuring two storage racks spaced away from each other with storage/retrieval means disposed inbetween. The storage/retrieval means comprises a platform for storage/retrieval of the totes between a bayway and bays. The platform-type storage totes run on rollers arranged in the deck of the bayway.

Shifting the totes in the bayway is noisy which becomes a nuisance especially with storage rackings having a plurality of bayways for the storage totes.

### BRIEF SUMMARY OF THE INVENTION

It is on the basis of this problem that the objective of the invention is to define a storage racking for reduced noise tote handling in the bayway.

This objective is achieved in accordance with the invention by the tread of the rollers comprising a noise-deadening insert.

Configuring the rollers with a noise-deadening insert in accordance with the invention reduces noise in tote handling in the bayway.

Advantageous embodiments of the invention are listed in the sub-claims.

Advantageously the noise-deadening insert is received by a groove machined into the roller tread. Preferably the groove is arranged circumferential with a depth dimensioned so that the insert “peeps” therefrom, resulting in a tote sliding on the tread first coming into contact with the noise-deadening insert. By varying the “peep”, i.e. the height of the insert protruding from the edges of the groove, deadening the noise can be varied accordingly.

In one advantageous aspect of the invention the insert is engineered elastomeric, resulting in the elastomeric inserts being squashed on storage motion of totes, primarily made of steel, on the roller in thus reducing the noise, whereas on retrieval motion of the tote from the roller the insert returns to its original shape because of its elastomeric response.

In another advantageous aspect of the invention the elastomeric insert is held in the groove positively connected, obviating the need for any additional fastener. Advantageously, the groove is configured dovetailed so that the insert can simply be urged into the groove without requiring any further fixation means. The taper of the dovetailed groove at the upper end ensures the insert being reliably held captive. As an alternative, however, the insert may also be bonded in place or materially incorporated in some other way with the groove in the roller tread.

In yet another advantageous aspect of the invention the tread of the rollers is made of polyamide. Polyamide has high abrasion resistance, making it hard-wearing. Apart from this, making the roller in polyamide is cost-effective.

The configuration in accordance with the invention now makes it possible to operate a storage racking with reduced noise. Fitting the rollers in accordance with the invention is cost effective and simple to install in the bayway.

### BRIEF DESCRIPTION OF THE SEVERAL VIEWS OF THE DRAWING(S)

The invention will now be detailed by way of a preferred embodiment with reference to the attached diagrammatic drawings in which:

FIG. 1 is view in perspective of a section of a racking system

FIG. 2 is a cross-section through a roller in accordance with the invention

FIG. 3 is a view of the bayway featuring short supporting arms and rollers

FIG. 4 is a view of the bayway with hinged supporting arms

FIG. 5 is a view of the bayway with hinged supporting arms and supporting feet

FIG. 6 is a view of the bayway with the supporting arms hinged down and supporting feet

### DETAILED DESCRIPTION OF THE INVENTION

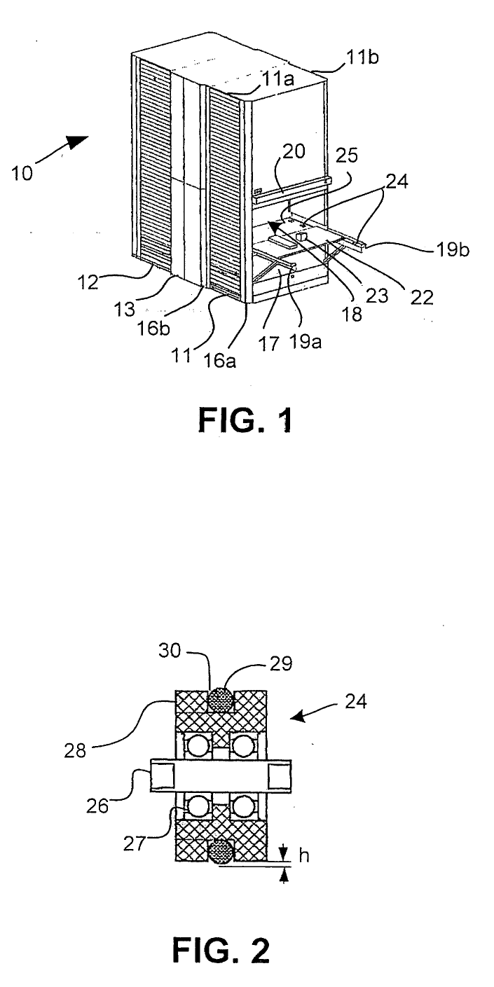

Referring now to FIG. 1 there is illustrated a racking system 10 in accordance with the invention comprising two racks 11,12 spaced away from each other with a storage/retrieval means 13 provided inbetween configured with a platform powered by roller chains. Each rack 11,12 comprises sidewalls 11a, 11b facing each other in parallel as defined on uprights 16a and 16b spaced away from each. The storage/retrieval means 13 comprises the platform (not shown) located on the roller chains (not shown) via which it can be raised and lowered in the racking system 10.

Provided at the face end 17 of the rack 11 is a bayway 18 on which support arms 19a, 19b jut forwards in parallel for storage/retrieval of the storage items 23 via the bayway 18. A lighting means 20 serves to illuminate the bayway 18. Deposited on the support arms 19a and 19b is the tote 22 for receiving the storage items 23. Via a height gauge (not shown) the height of the items 23 for storage is sensed.

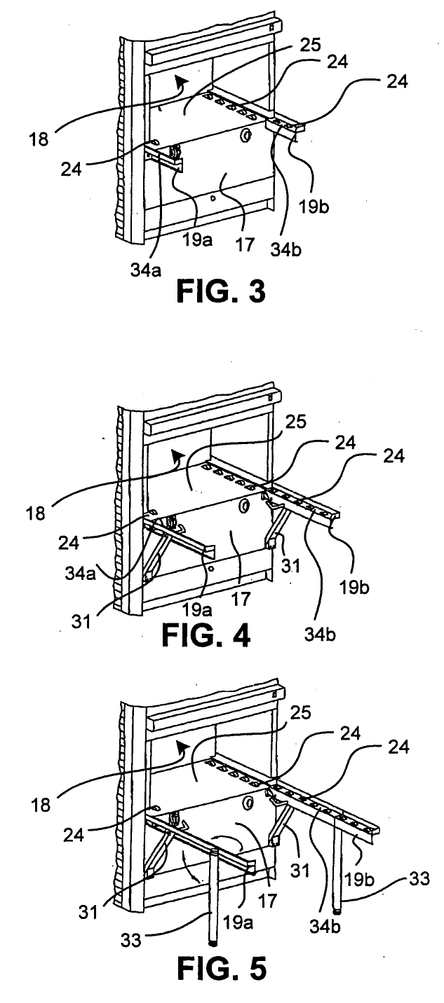

Referring now to FIG. 3 there is illustrated how rollers 24 are arranged in the deck 25 of the bayway 18. The rollers 24 are located on the two outer edges of the deck 25. The rollers 24 are ball-bearing mounted to “peep” out of the deck 25. The rollers 24 are also arranged in the support arms 19a and 19b jutting out horizontal to thus facilitate shifting the deposited totes 22 relative to the bayway 18.

Referring now to FIG. 2 there is illustrated a cross-section through a roller 24 in accordance with the invention. The roller 24 rotates on a shaft 26 in a ball bearing 27 or plain bearing. The tread 28 of the roller 24 is made of polyamide. Machined into the tread 28 of the rollers 24 is a circumferential groove 30. This groove 30 serves to receive a noise-deadening insert 29. This insert 29 is engineered elastomeric and is made of rubber. The annular insert 29 has a circular cross-section. The insert 29 peeps from the groove 30 by the amount “h”.

In storage motion of the totes 22 the rolling noise is deadened in thus reducing the noise caused by shifting the totes 22 in the bayway 18. The elastomeric material of the insert 29 is squashed on the storage motion, it returning to its original shape on the retrieval motion of the totes 22 from the roller 24 because of its elastomeric response.

Referring now to FIG. 3 there is illustrated an aspect of the bayway 18 featuring short support arms 19a and 19b. To permit shifting the totes 22 on the support arms 19a and 19b, here too, rollers 24 are inserted in the faces 34a and 34b of the support arms 19a and 19b.

Referring now to FIG. 4 there is illustrated the bayway 18 of the storage racking 10 as shown in FIG. 1, here on a magnified scale. In this case the support arms 19a and 19b are configured longer than as shown in FIG. 3, the loading capacity of the support arms 19a and 19b being enhanced by supporting means 31.

Referring now to FIG. 5 there is illustrated how a bayway 18 of the storage racking 10 is provided with support arms 19a and 19b featuring support feet to take the load of heavier totes 22. Here too, rollers 24 are inserted in the support arms 19a and 19b.

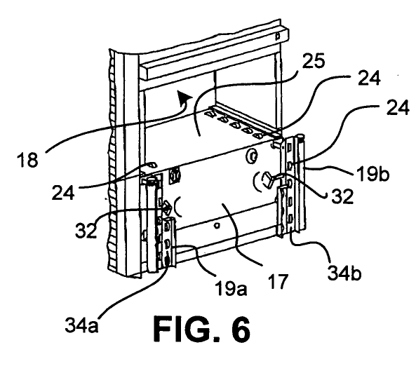

Referring now to FIG. 6 there is illustrated how the bayway 18 features support arms 19a and 19b hinged down and supporting means 31 and supporting feet 33 hinged in, the support arms 19a and 19b featuring handles 32 with which they can also be hinged open when required.

1. A storage racking comprising a plurality of stacked, spaced tote supports arranged in pairs on opposing sidewalls for receiving platform-type totes for storage items, provided with storage/retrieval means for moving said totes in and out of bays in said storage racking, storage and retrieval of said totes being via a bayway comprising rollers arranged in the deck of said bayway for horizontally shifting said totes, wherein the tread of said rollers comprises a noise-deadening insert.

2. The storage racking as set forth in claim 1, wherein said noise-deadening insert is received by a groove machined into the tread of said rollers.

3. The storage racking as set forth in claim 1, wherein said noise-deadening insert is configured annular.

4. The storage racking as set forth in claim 1, wherein said insert is engineered elastomeric.

5. The storage racking as set forth in claim 1, wherein said insert comprises a circular cross-section.

6. The storage racking as set forth in claim 2, wherein said groove is configured dovetailed.

7. The storage racking as set forth in claim 1, wherein said rollers comprise a tread of polyamide.
